(19) United States
(12) Patent Application Publication
(10) Pub. No.: US 2004/0122152 A1
(43) Pub. Date: Jun. 24, 2004

(54) Viscous compositions containing hydrophobic liquids

(76) Inventors: Ashoke K. SenGupta, Barrington, IL (US); David McGregor, Grayslake, IL (US); Ralph Spindler, Palatine, IL (US); Kevin Cureton, Evanston, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/626,009

(22) Filed: Jul. 24, 2003

Related U.S. Application Data
(60) Provisional application No. 60/455,049, filed on Mar. 14, 2003.
(60) Provisional application No. 60/398,631, filed on Jul. 25, 2002.

(51) Int. Cl. C08K 3/26

(52) U.S. Cl. 524/425; 524/435; 524/449; 524/445; 524/437; 524/451; 524/432; 524/423; 524/386

(57) ABSTRACT

A composition for thickening hydrophobic liquids, and for dispersing and suspending particulate materials in a hydrophobic liquid, is disclosed. The composition contains a layered silicate material having its surface modified by an adsorbed amphipathic copolymer. The composition typically is dispersed in a hydrophobic liquid or in glycol-water mixture for easy addition to, and dilution in, hydrophobic liquid-based formulations.

### CROSS-REFERENCE TO RELATED APPLICATIONS

This application claims the benefit of U.S. provisional patent application Serial No. 60/455,049 filed Mar. 14, 2003, and U.S. provisional patent application Serial No. 60/398,631, filed Jul. 25, 2002.

### FIELD OF THE INVENTION

The present invention relates to hydrophobic liquid-based compositions thickened by a layered silicate material. More particularly, the present invention relates to a layered silicate material for the thickening or gelation of hydrophobic liquids using the layered silicate material, wherein surfaces of the silicate material are modified by an adsorbed amphipathic polymer. The amphipathic polymer is a block or graft copolymer prepared from a hydrophilic comonomer and a hydrophobic comonomer. The surface-modified layered silicate material effectively thickens hydrophobic liquids, and disperses and suspends particulate materials, like pigments, in a hydrophobic liquid. The present compositions can be used in producing cosmetic, pharmaceutical, and personal care products including liquid makeups, eye shadows, mascaras, lip colors, nail products, antiperspirants, deodorants, and sunscreens, as well as paints and coatings.

### BACKGROUND OF THE INVENTION

Thickening of hydrophobic liquids is of great interest in the formulation of personal care, cosmetic, pharmaceutical, paint, and coating products. Presently, only a few materials are available that can be used cost effectively as a thickening agent for hydrophobic liquids. For use in personal care and cosmetic formulations, it is important that the thickening additive neither causes skin irritation nor adversely affects the esthetics of the final product. The present invention is directed to materials that effectively thicken hydrophobic liquid-based compositions, while overcoming disadvantages of prior thickeners.

Layered silicates, such as the smectite clays, are a class of inorganic particulate materials that exist as stacks or aggregates of planar, or plate-like, silicate layers, referred to as platelets. The clays can be natural or synthetic in origin. Examples of smectite clays include, but are not limited to, montmorillonite, bentonite, bidelite, hectorite, saponite, and stevensite. These clays are well-known gellants or thickeners, but for aqueous compositions.

In particular, the formation of particulate gels is a result of suspended colloidal particles forming a particulate network structure that entraps, and thus immobilizes, the suspending medium. Clay-based gels can form when individual platelets or stacks of a few aggregated platelets (i.e., tactoids) engage in interparticle associations with neighboring platelets in a suspension. These particle-to-particle links result in a particulate structure pervading through the entire suspension. Such interparticle associations are governed by the interplay between the attractive and repulsive forces that generally act between suspended particles.

When suspended in an aqueous medium, the clay platelets stacked in an aggregate are forced apart across their face-surfaces, a phenomenon known as delamination or exfoliation of clay platelets. The face-surface of the clay platelets has an anionic charge. Therefore, adjacent clay platelets in a stack, when wetted by water, repel one another due to a phenomenon termed “electrical double layer repulsion.” Presumably, therefore, the electrical repulsion between the clay platelets plays a mechanistic role in the delamination process. Delamination of the clay platelets releases a large number of platelets in the suspension, which then can form the particulate network leading to the thickening or gelation of the aqueous suspending medium.

An important factor in providing clay-based gels is to ensure that sufficient interplatelet repulsion exists for the clay platelets to exfoliate (e.g., delaminate or deflocculate) under shear, thereby releasing a large number of platelets as individual platelets or tactoids having fewer stacked platelets, which then are available to form a particle network. On the other hand, in order to form a voluminous network structure, the net interaction (e.g., the sum of attractive and repulsive forces) between the delaminated platelets must be such that they can remain “bound” (e.g., attracted) to neighboring platelets while avoiding strong coagulation with neighboring platelets via face-to-face associations.

Accordingly, a gel network can form when delaminated platelets reside in a minimum in free energy of interaction with neighboring platelets, while being separated from neighboring platelets by a sufficiently thick intervening layer of the suspending medium. Although physically separated from neighboring platelets, the individual platelets are no longer free to move independently. They are trapped in a free energy minimum which in effect produces a particulate network structure that is required to provide thickening or gelation. Clay-based gels also can form in aqueous compositions when clay platelets coagulate due to edge-to-face associations, forming a so-called “card-house” structure.

Forming clay-based gels, therefore, requires tuning of interplatelet forces, for example, by modification of the clay surface. Adding complexity, the attractive and repulsive forces between clay platelets can vary with the properties of the suspending medium. This is demonstrated by the fact that clay-based gels easily form in water or aqueous-based compositions, but not in hydrophobic organic solvents.

It is, therefore, an object of the present invention to modify the surface of a layered silicate material, preferably a smectite clay, in a manner such that the silicate material effectively thickens or gels hydrophobic liquids (i.e., nonpolar liquids that are essentially insoluble in, or immiscible with, water), particularly hydrophobic liquids used in personal care and cosmetic compositions. An important aspect of such clay-surface modification is to prevent strong face-to-face aggregation of the clay platelets, such that the suspended state of the delaminated platelets is preserved over extended time.

In nonaqueous media, however, especially in hydrophobic liquids having a dielectric constant of less than about 10, the electrical repulsion between the face-surfaces of the clay platelets may be too weak to support exfoliation of the clay platelets. As a result, the face-surfaces of the clay platelets are modified in order that clay can thicken hydrophobic liquids effectively. Any modification of platelet surfaces must provide a mechanism for reducing the van der Waals attraction that holds the platelets together in a stack (i.e., the “semi-steric stabilization”) and/or interplatelet repulsion via “steric repulsion.” Adsorption of a polymer on the platelet surfaces is in a manner such that the polymer chain extends into the suspending medium to form loops and tails could provide for interplatelet steric repulsion.

The cosmetic, personal care, paint, and coating products that require thickening of hydrophobic liquids generally are suspensions of solid particulate materials, like pigments, for example. For these products, thickening of the hydrophobic suspending medium can minimize or eliminate settling of the solid particles such that the particles remain suspended for months or years.

However, while these products preferably are viscous when left standing (i.e., under static conditions), it also is desirable that product viscosity drops substantially when the product is subjected to shear, i.e., the product is thixotropic. Shear thinning makes the products easier to apply and/or increases the coverage per application stroke of the products. It is, therefore, an aspect of the present invention to provide hydrophobic liquid-based compositions that are thixotropic, while having high viscosities under static conditions. A related aspect of the present invention is to modify the surface of a layered silicate material, preferably a smectite clay, in a manner such that the surface-modified clay can perform as an effective thickener or gellant for hydrophobic liquid-based liquids, and can provide thixotropic compositions.

The suspended particulate solids, such as iron oxide, titanium dioxide, mica, organic pigments, and the like used in color cosmetic formulations, the aluminum zirconium salts used in anti-perspirants, and the inorganic oxides, like titanium dioxide and zinc oxide, used as ultraviolet radiation filters (UVR) in sunscreen formulations, are functional components of these compositions. The efficacy of these functional solids invariably depends on their number-concentration in the suspension, the particle surface area available for a given dosage of the solids, and, therefore, on their state of dispersion in the product formulations, including during product application. This is because the more dispersed or deflocculated the particles, the greater the number-concentration of suspended particles or the greater the particle surface area that is available for a given dosage of the suspended particles. It is, therefore, a further aspect of the present invention to utilize a polymer to modify the surfaces of a smectite clay, which can also perform as a dispersing or deflocculating agent for particulate solids suspended in hydrophobic liquids.

In the prior art, smectite clay surfaces are modified by attaching a long-chain (C₈-C₂₅) quaternary surfactant (often derived from tallow) to clay surfaces, thus providing what is traditionally known as an “organoclay” that can thicken hydrophobic liquids. The term organoclay generally refers to layered silicate materials, such as the smectite clays, whose surfaces are rendered hydrophobic or organophilic by the adsorption of a long-chain (C₈-C₂₅) quaternary surfactant on the clay surface. The face-surfaces of smectite clays bear anionic charges counterbalanced by exchangeable cations that remain electrostatically associated with the anionic charge of the clay surface. A cationic surfactant attaches onto the clay surface via ion exchange, presumably such that the hydrophobic portion of the surfactant molecule (i.e., the tail) projects out from the clay surface into the surrounding hydrophobic liquid. Due to this “tail-out” orientation of the adsorbed quaternary surfactant, the clay surface is rendered hydrophobic. Not only do the adsorbed cationic surfactants make the clay surface hydrophobic, and, therefore, wettable by a hydrophobic solvent, they also enable the clay platelets to delaminate when the clay slurry is subjected to shear forces in the hydrophobic solvent. Such delamination of the clay platelets releases a large number of suspended clay platelets that then can form the particle network structure needed for thickening or the gelation of the hydrophobic liquid.

The quaternary surfactant-modified organoclays pose several problems to a cosmetic formulator. For example, quaternary surfactants can cause skin irritation. Tallow-derived cationic surfactants also often are not desired as cosmetic product ingredients due to health and religious reasons. A long-chain (C₈-C₂₅) quaternary surfactant also may not be an effective dispersing agent for optical brightener pigments (e.g., titanium dioxide) in hydrophobic liquids. As a result, it may not be possible to provide ultrabright organoclays, that are desirable in many cosmetic products, using the conventional organoclay chemistry described above.

Therefore, an important aspect of the present invention is to provide novel organoclay compositions that overcome the disadvantages associated with the traditional organoclays, while providing good dispersion or deflocculation of pigment or other functional solid particles in hydrophobic liquids. The present polymer-mbdified organoclays provide cosmetic, personal care, paint, and coating compositions having excellent thixotropic properties, with enhanced performance from, or a greater utilization of, dispersed functional particulate solids, including coloring pigments, antiperspirant actives, and inorganic oxides used as ultraviolet radiation filters.

### SUMMARY OF THE INVENTION

The present invention relates to hydrophobic liquid-based compositions thickened by a layered silicate material, wherein surfaces of the layered silicate are modified by an adsorbed amphipathic polymer. The amphipathic polymer is a block or a graft copolymer prepared from a hydrophilic comonomer and a hydrophobic comonomer, and renders the layered silicate material capable of thickening hydrophobic liquids. The relative proportion of the hydrophobic comonomer and the hydrophilic comonomer of the copolymer is such that the copolymer as a whole is essentially soluble or dispersible in hydrophobic liquids. Examples of layered silicate materials include the smectite clays and sodium lithium magnesium silicates, i.e., the LAPONITE® clays. The hydrophobic liquids typically have a dielectric constant of less than about 10, and ordinarily are referred to as an “oil.” The hydrophobic liquid is nonpolar, and is essentially insoluble in, and immiscible with, water and other hydrophilic liquids. The hydrophobic liquids include, but are not limited to, “oil-like” liquids commonly used in cosmetic and personal care formulations, including silicone fluids, ester solvents, mineral oil, liquid hydrocarbons, and flower oils.

The present compositions can further contain other particulate materials, like pigments, in addition to a polymer-modified, layered silicate, suspended in a hydrophobic liquid, wherein the amphipathic polymer used for the surface-modification of the layered silicate also disperses or deflocculates the particulate material. The compositions additionally can include at least one optional thickening aid, typically selected from the group consisting of propylene carbonate, hexylene glycol, ethanol, water, propylene glycol, and the like, to assist the surface-modified layered silicate material in thickening hydrophobic liquids, even at relatively low concentrations. The compositions produced therefrom can be cosmetic and personal care products including lip colors, mascara, eye shadow, makeup, sunscreen, nail polishes, antiperspirants, and deodorants, as well as paints and coatings.

In particular, the present invention provides a novel composition and method of thickening hydrophobic liquids, and to compositions produced therefrom. More specifically, the hydrophobic liquids include any oil-like substance that does not dissolve in, and is not miscible with, water. The thickening agent for the hydrophobic liquid is a surface-modified, layered silicate material, such as the smectite clays and lithium magnesium silicates.

Although these clays in unmodified form are known for their ability to thicken water or aqueous compositions, they do not thicken hydrophobic liquids unless rendered dispersible in hydrophobic solvents by modifying their surface. In the present invention, the clay surface is modified using block or graft copolymers wherein one of comonomers of the copolymer generates a homopolymer that is nominally insoluble, and the second comonomer of the copolymer generates a homopolymer that is soluble, in the hydrophobic liquid. These copolymers also are capable of acting as a dispersing agent for a functional particulate material (e.g., pigments and particulate UV filters) in the hydrophobic liquids. As a result, functional particulate compounds, like optical brightener pigments, such as titanium dioxide, kaolin, and calcium carbonate, can be co-dispersed with a layered silicate of the present invention in a hydrophobic solvent to increase the brightness of the composition.

These and other novel aspects and advantages of the present invention will become apparent from the following detailed description of the preferred embodiments.

### DETAILED DESCRIPTION OF THE PREFERRED EMBODIMENTS

The present invention relates to polymer-modified, layered silicate materials for thickening hydrophobic liquids, to compositions thickened by the layered silicate materials, and a method of producing these compositions. The polymer-modified silicate materials comprise at least one layered silicate material whose surface is modified by an amphipathic copolymer. The layered silicate material preferably comprises a smectite clay, nonlimiting examples of which include montmorillonite, bentonite, bidelite, hectorite, saponite, and stevensite; a sodium lithium magnesium silicate, e.g., a LAPONITE® clay; and mixtures thereof. The polymer-modified layered silicate effectively thickens hydrophobic liquids.

The hydrophobic liquids are nonpolar, oil-like solvents that are insoluble in, and immiscible with, water, and have a dielectric constant of less than about 10. Examples of hydrophobic liquids include, but are not limited to, silicone fluids, esters, mineral oil, liquid hydrocarbons, vegetable or plant oils, and mixtures thereof.

The copolymers useful in the present invention are graft or block polymers prepared from (a) a first comonomer that generates a hydrophilic homopolymer which is essentially insoluble in hydrophobic liquids and (b) a second comonomer that generates a hydrophobic homopolymer which is soluble in hydrophobic liquids. The relative proportion of the hydrophobic second comonomer and the hydrophilic first comonomer is such that the copolymer, as a whole, is soluble or dispersible in hydrophobic liquids.

As used herein, a material is “insoluble” in a solvent when the material dissolves in the solvent to an extent of no more than 0.5 g of the material per 100 g of the solvent. “Essentially insoluble” is defined as dissolving no more than 0.1 g of the material per 100 g of the solvent.

It is theorized, but not relied upon herein, that useful copolymers adsorb on the surface of a layered silicate to act as a dispersing or delaminating agent in hydrophobic liquids by the following mechanism. In particular, the hydrophilic component of the copolymer, which is essentially insoluble in the hydrophobic liquid, adsorbs onto the particulate surface of the layered silicate, and is termed herein as the “anchor” portion of the copolymer, while the hydrophobic (i.e., soluble) portion of the copolymer, termed herein as the “stabilizing” portion of the copolymer, extends into the hydrophobic solution phase, thereby providing the steric repulsion forces that prevent the layered silicate particles coated with the copolymer from undergoing strong coagulation across their face-surfaces. In the case of clay platelets, such interplatelet repulsion leads to delamination of the platelets.

The foregoing type of copolymers potentially can adsorb on any particulate surface because they do not require specific interactions, such as ion-exchange, electrostatic, hydrophobic, hydrogen bonding, or acid-base interactions, to drive adsorption onto a surface. Therefore, these copolymers can perform as an effective dispersing or deflocculating agent for any particulate material, as long as i) the stabilizing portion of the copolymer is soluble in the suspending medium, and ii) the conformation of the adsorbed polymer is conducive to generating the steric repulsion forces. As previously mentioned, polymer conformations that support steric repulsion include those where segments of the adsorbed polymer extend out from the particle surface in the form of loops and tails. The interactions of polymer segments with the particle surface and with the surrounding solvent are the mechanistic elements that control the interfacial (i.e., at the particle surface) conformation of the adsorbed polymer.

The anchor portion of the copolymer can be, for example, but not limited to, poly(oxyethylene), poly(propylene glycol), poly(vinyl chloride), a poly(acrylate), a poly(acrylamide), or mixtures thereof. The stabilizing portion of the copolymer can be, for example, but not limited to, poly(hydroxystearate), poly(12-hydroxystearic acid), poly(lauryl methacrylate), polystyrene, poly(dimethylsiloxane), poly(vinyl acetate), poly(methyl methacrylate), poly(vinyl methyl ether), or mixtures thereof. As mentioned above, it is important that the polymeric surface modifier for the layered silicate is a copolymer, graft or block, of an anchoring polymer and a stabilizing polymer, and is not an anchoring or stabilizing polymer alone.

Two particularly useful copolymers are PEG-30 dipolyhydroxystearate, Uniqema, New Castle, Del., and BIS-PEG 15 dimethicone/IPDI copolymer (i.e., a polydimethylsiloxane-polyoxyethylene 15 polymer copolymerized with 3-isocyanatomethyl-3,5,5-trimethylcyclohexyl isocyanate), available from Alza International, Sayerville, N.J.

An important embodiment of the present invention is that a particulate material, other than a layered silicate material, termed herein a functional particulate material, can be codispersed with the layered silicate material in a hydrophobic liquid. Such a functional particulate material can be, for example, but not limited to, iron oxide, titanium dioxide, a coloring dye, organic pigments, calcium carbonate, kaolinite clay, alumina, talc, zinc oxide, calcium sulfate, an aluminum zirconium salt, and mixtures thereof.

A layered silicate-based thickener for hydrophobic solvents of the present invention can be produced as follows. The copolymer first is dissolved in a hydrophobic liquid. A single layered silicate material, or a mixture of layered silicate materials, is added to the resulting solution, optionally with one or more functional particulate material. The resulting slurry is homogenized in a high shear mixer, or in an extruder, for a sufficient period of time. After the slurry is thoroughly homogenized, an optional “thickening aid” can be added to the slurry to cause interactions between the delaminated or dispersed clay platelets, wherein individual platelets or tactoids engage in interplatelet associations with neighboring platelets to form a particle network that leads to thickening of the hydrophobic liquid or liquid mixture. A thickening aid can be, for example, but not limited to, propylene carbonate, hexylene glycol, propylene glycol, ethanol, water, and mixtures thereof.

Alternatively, the layered silicate-based thickeners for hydrophobic liquids of the present invention can be produced in the form of an additive for personal care, cosmetic, paint, and coating formulations. Such an additive thickener comprises a concentrated, viscous dispersion or gel containing (a) at least one layered silicate material having an amphipathic copolymer of the type described above adsorbed on its surfaces, (b) optionally, one or more functional particulate material, in (c) a hydrophobic liquid, and (d) one or more thickening aid. The additive thickener can be produced by the aforementioned process, and can be diluted in a cosmetic, a personal care, a paint, or coating formulation that in turn also can contain one or more functional particulate material.

It has been found that a single thickening aid may not perform in all hydrophobic liquids or liquid mixtures, and that not all hydrophobic liquids or liquid mixtures require the use of a thickening aid. For example, hexylene glycol performs in mineral oil, but not in a mixture of cyclomethicone (silicone oil) and capric/caprylic triglyceride (an ester solvent). Also, it was found that a particular amphipathic copolymer may not perform as a delaminating/dispersing agent for a silicate material or functional particulate material in a particular hydrophobic liquid, but rather may require a mixture of the hydrophobic liquid with a second hydrophobic liquid to be effective. For example, poly(ethyleneglycol-30)-co-dipoly(hydroxystearate) does not perform in cyclomethicone (Dow Corning 345 fluid) alone, but performs in various mixtures of cyclomethicone and ester solvents, such as capric/caprylic triglyceride, C₁₂₋₁₅ alkyl benzoate, diisopropyl adipate, and the like.

The amounts of the various components in a thickened hydrophobic liquid composition of the present invention, as a percentage of the total weight of the composition, are given below:

| | |
|---|---|
| Hydrophobic solvent | about 30 to about 90% |
| Layered silicate | about 0.5 to about 70% |
| Copolymer | about 0.025 to about 35% |
| Thickening aid | 0 to about 20% |

Optionally, the compositions can contain about 0.5% to about 60%, by weight, of one or more functional particulate material, for example, iron oxide, titanium dioxide, a coloring dye, an organic pigment, calcium carbonate, kaolinite clay, alumina, talc, zinc oxide, calcium sulfate, an aluminum zirconium salt, and mixtures thereof.

In another important embodiment of the present invention, a layered silicate material-based gel is produced in a hydrophobic solvent or in a mixture of hydrophobic solvents, containing an amphipathic copolymer to disperse and delaminate the layered silicate material. The amounts of the various components of the gel are as follow:

| | |
|---|---|
| Hydrophobic solvent | about 30 to about 90% |
| Thickening aid | 0 to about 20% |
| Layered silicate | about 5 to about 70% |
| Copolymer | about 0.025 to about 50% |

The resulting gel is added to a hydrophobic liquid or a mixture of hydrophobic liquids to achieve thickening of the liquid or the liquid mixture. Such a gel material is produced using a high shear mixer or an extruder, and optionally can contain about 0.5% to about 60%, by weight, of one or more functional particulate material, such as iron oxide, titanium dioxide, a coloring dye, an organic pigment, calcium carbonate, kaolinite clay, alumina, talc, zinc oxide, calcium sulfate, an aluminum zirconium salt, and mixtures thereof.

In yet another important embodiment of the present invention, a layered silicate material-based gel is produced in a mixture of a glycol and water. The gel contains an amphipathic copolymer as a dispersing and delaminating agent for the layered silicate material. The amphipathic copolymer dispersing agent can be present in the gel in soluble form or in the form of emulsion droplets stabilized by an emulsifier. The proportions of the various components of the gel are as follow, by weight %:

| | |
|---|---|
| Glycol solvent | about 30 to about 90% |
| Water | about 5 to about 30% |
| Layered silicate | about 5 to about 70% |
| Copolymer | about 0.025 to about 35% |
| Emulsifier | about 0.00025 to about 0.0025% |

The resulting gel is added to a hydrophobic liquid or a mixture of hydrophobic liquids to thicken the liquid or the liquid mixture. Such a gel material is produced using a high shear mixer or an extruder, and optionally can contain about 0.5% to about 60%, by weight, of one or more functional particulate material, such as iron oxide, titanium dioxide, a coloring dye, an organic pigment, calcium carbonate, kaolinite clay, alumina, talc, zinc oxide, calcium sulfate, an aluminum zirconium salt, and mixtures thereof.

In order to illustrate the present invention, the following nonlimiting examples are presented. The following data and examples are included as illustrations of the present invention and should not be construed as limiting scope of the invention.

### EXAMPLE 1

This example illustrates compositions of the present invention, wherein various hydrophobic liquids contain the copolymeric dispersing agent poly(ethylene glycol-30)-co-dipoly(hydroxystearate), i.e., ARLACEL® P-135 from Uniqema, New Castle, Del. The viscous, gel-like dispersion compositions summarized in Table 1, having a Brookfield viscosity exceeding 400,000 cps at 10 rpm, can be diluted in metic, personal care, paint, and coating formulations to produce the final product. All of the gel compositions listed in Table 1 were prepared by mixing the ingredients in a KitchenAid mixer, during which the composition became viscous, followed by passing the viscous dispersion through a laboratory extruder three times.

TABLE 1

| | Sodium | Titanium | | | Propylene | Polymeric |
|---|---|---|---|---|---|---|
| Gel | Bentonite | Dioxide | Liquid 1 | Liquid 2 | Carbonate | Dispersant |
| No. | Clay (g) | (g) | (g) | (g) | (g) | (g) |
| 1 | 180 | 30 | Cyclomethicone, | C₁₂₋₁₅ alkyl | 54 | 117 |
| | | | 256.5 | benzoate, | | |
| | | | | 193.5 | | |
| 2 | 180 | | Cyclomethicone, | C₁₂₋₁₅ alkyl | 54 | 117 |
| | | | 256.5 | benzoate, | | |
| | | | | 193.5 | | |
| 3 | 270 | 45 | | C₁₂₋₁₅ alkyl | 81 | 175.5 |
| | | | | benzoate, | | |
| | | | | 675 | | |
| 4 | 270 | | | C₁₂₋₁₅ alkyl | 81 | 175.5 |
| | | | | benzoate, | | |
| | | | | 675 | | |
| 5 | 270 | | Isododecane, | | 81 | 175.5 |
| | | | 500 | | | |

### EXAMPLE 2

This example shows that an organoclay additive composition of the present invention, denoted by Gel #1 in EXAMPLE 1, exhibits a higher low-shear viscosity and a higher level of shear thinning (reduction in viscosity with increase in shear rate) compared to a traditional organoclay product. Gel #1 and the traditional organoclay product (i.e., BENTONE® VS5 PCV from Elementis) were diluted individually in a hydrophobic liquid comprising of a mixture of a silicone fluid (cyclomethicone, Dow Corning 345 fluid), C₁₂₋₁₅ alkyl benzoate (FINSOLV® TN from Finetex Inc.), and isododecane (PERMETHYL® 99A from Presperse Inc.), by homogenizing the dispersion composition in a Waring blender at 22,000 rpm for 5 minutes. The Brookfield viscosities of the diluted dispersions are tabulated in Table 2, wherein the applied shear-rate is directly proportional to the rpm of the spindle used in a Brookfield RVT viscometer, i.e., the higher the rpm, the greater the shear rate. The 0.5 rpm-viscosity was noted after allowing two full turns of the spindle, and the 10 rpm-viscosity was noted after allowing the spindle to rotate for 15 seconds. The viscosity measurements were performed after at least 24 hours of standing of the diluted dispersion composition. In Table 2, the solids amount of the organoclay material is based on the total weight of the diluted suspension, while the proportions of the various hydrophobic liquids contained in the suspension is based on the weight of the liquid portion of the suspension.

TABLE 2

| | | | | | Brookfield | |
|---|---|---|---|---|---|---|
| | | | C₁₂₋₁₅ | | Viscosity | |
| Test | Organoclay | | alkyl | | | Viscosity, |
| No. | Solids % | Cyclomethicone % | benzoate % | Isododecane % | rpm | cps |
| 1 | Gel #1 | 57 | 21.5 | 21.5 | 0.5 | 110,000 |
| | 4.47 | | | | 10 | 10,600 |
| 2 | BENTONE ® | 57 | 21.5 | 21.5 | 0.5 | 30,000 |
| | VS5 PCV 5 | | | | 10 | 13,900 |

### EXAMPLE 3

This example shows the thickening, shear thinning, and viscosity recovery (upon reduction of shear rate) properties of gel compositions of the present invention that are similar (unless otherwise specified) in composition to Gel #1 in Table 1, but manufactured using an industrial extruder. The gel was diluted in a given weight of a hydrophobic liquid or a mixture of hydrophobic liquids using the procedure described in EXAMPLE 2. The results of the Brookfield viscosity measurements (performed after at least 24 hours of standing of the diluted dispersion) are summarized in Table 3. The spindle revolution rate (proportional to the applied shear rate) was increased from 0.5 rpm to 10 rpm, and then further to 20 rpm, before reducing the revolution rate back to 0.5 rpm.

TABLE 3

| | | | | Brookfield | |
|---|---|---|---|---|---|
| | Gel | | | Viscosity | |
| Test | Dosage | Liquid 1 | Liquid 2 | | Viscosity, |
| No. | (g) | (g) | (g) | rpm | cps |
| 1 | 31.26 | Isododecane | | 0.5 | 50,000 |
| | | 168.74 | | 10 | 9,000 |
| | | | | 20 | 5,625 |
| | | | | 0.5 | 50,000 |
| 2 | 31.26 | Cyclomethicone | C₁₂₋₁₅alkyl | 0.5 | 120,000 |
| | | 96.18 | benzoate | 10 | 29,000 |
| | | | 72.56 | 20 | 16,500 |
| | | | | 0.5 | 170,000 |
| 3 | 31.26 | Capric/caprylic | | 0.5 | 280,000 |
| | | triglyceride | | 10 | 20,000 |
| | | 168.74 | | 20 | 10,500 |
| | | | | 0.5 | 300,000 |
| 4 | 31.26 | Castor Oil | | 0.5 | 1,320,000 |
| | | 168.74 | | 10 | 108,000 |
| | | | | 20 | 56,000 |
| | | | | 0.5 | 1,280,000 |
| 5 | 31.26 | C₁₂₋₁₅alkyl | | 0.5 | 360,000 |
| | | benzoate | | 10 | 66,500 |
| | | 168.74 | | 20 | 34,000 |
| | | | | 0.5 | 280,000 |
| 6 | 31.26 | Cyclomethicone | Diisopropyl | 0.5 | 110,000 |
| | | 96.18 | adipate | 10 | 32,000 |
| | | | 72.56 | 20 | 15,000 |
| | | | | 0.5 | 140,000 |
| 7 | 31.26 | Cyclomethicone | Dioctyl | 0.5 | 110,000 |
| | | 96.18 | sebacate | 10 | 24,000 |
| | | | 72.56 | 20 | 14,625 |
| | | | | 0.5 | 130,000 |
| 8 | 30 | Isoparaffin | Diisopropyl | 0.5 | 65,000 |
| | | 85 | adipate | 10 | 19,000 |
| | | | 85 | 20 | 13,000 |
| | | | | 0.5 | 60,000 |
| 9 | 40 | Isoparaffin | | 0.5 | 30,000 |
| | | 160 | | 10 | 17,000 |
| | | | | 20 | 9,500 |
| | | | | 0.5 | 30,000 |
| 10 | 10 | Butyl acetate | Ethyl acetate | 0.5 | 20,000 |
| | Gel #2 | | | 10 | 2,000 |
| | (Table 1) | | | 20 | 550 |
| | | | | 0.5 | 10,000 |

### EXAMPLE 4

This example shows the dispersing/deflocculating ability of the copolymeric dispersing agent, poly(ethylene glycol-30)-co-dipoly(hydroxy-stearate), i.e., ARLACEL® P-135, contained in a composition of the present invention. The extent of deflocculation of suspended particles in concentrated dispersions can be assessed from the suspension viscosity, wherein a lower viscosity indicates a dispersion with particles that are deflocculated to a greater extent. Accordingly, the evaluation of the dispersing ability of the copolymer was performed by measuring the viscosity of concentrated suspensions of iron oxide, titanium dioxide, and aluminum zirconium salt, with and without the co-polymer. A Brookfield RVT viscometer was used for measuring the suspension viscosity.

A given weight of a functional particular material was added to a dispersant solution comprising a 60:40 (parts by weight) mixture of cyclomethicone and C₁₂₋₁₅ alkyl benzoate, a given amount of the copolymeric dispersant, and a 3.34 g aliquot of a 1:1 mixture (by weight) of propylene carbonate and deionized water. The resulting slurry was homogenized in a Waring blender at 2,000 rpm for a total mixing time of four minutes. The slurry then was transferred to a plastic cup and its viscosity measured after 15 minutes from the time of completion of mixing. The results of these slurry viscosity tests are summarized in Table 4. In Table 4, the pigment dosage is based on the weight of the slurry (excluding the weight of the copolymeric dispersant), and the dispersant dosage is based on the weight of the pigment.

TABLE 4

| | | Brookfield |
|---|---|---|
| Functional Material, | | Viscosity, |
| Dosage % | Dispersant Dosage | cps, 10 rpm |
| Aluminum zirconium salt | 0 | 22,000 |
| 54.74 | 1 | 500 |
| | 3 | 150 |
| | 5 | 100 |
| Titanium dioxide | 0 | 15,000 |
| 38.61 | 4 | 250 |
| | 5 | 100 |
| Iron Oxide | 0 | Too viscous |
| 32.61 | 5 | 750 |
| | 8 | 260 |

Therefore, an important aspect of the present invention is to provide novel organoclay compositions that overcome disadvantages encountered with traditional organoclays, such as skin irritation and the use of tallow-derived materials. A further aspect is to use a clay surface-modification chemistry that enables not only the delamination of clay platelets in hydrophobic liquids, but also provides a good dispersion of functional particulate materials codispersed with the clay in the hydrophobic liquid.

### EXAMPLE 5

A given amount of a copolymer dispersing agent, i.e., ARLACEL® P-135, was dissolved in a hydrophobic solvent. A measured amount of a sodium bentonite clay was added to the resulting solution. The resulting slurry was homogenized in a Waring blender der at 22,000 rpm for about 2.5 to 3 minutes, after which a thickening aid was added. The slurry was homogenized for an additional 2 to 2.5 minutes, transferred to a plastic container, and tested for Brookfield viscosity. Table 5 summarizes the results of the slurry viscosity tests.

TABLE 5

| | | | | | Brookfield |
|---|---|---|---|---|---|
| Test | Clay | Hydrophobic | Copolymer | Thickening | Viscosity, |
| No. | (g) | Liquid | (g) | Aid | cps 10 rpm |
| 1 | 10 | Mineral Oil | 3 | Hexylene | 4,5000 |
| | | 184 g | | glycol | |
| | | | | 3 g | |
| 2 | 10 | Mineral Oil | 4 | Hexylene | 9,000 |
| | | 183 g | | glycol | |
| | | | | 3 g | |
| 3 | 10 | Mineral Oil | 4 | Hexylene | 15,300 |
| | | 180 g | | glycol | |
| | | | | 6 g | |
| 4 | 0 | Mineral oil | 4 | Hexylene | No |
| | | 183 g | | glycol | thickening |
| | | | | 3 g | |
| 5 | 10 | DC 345 fluid | 4 | Hexylene | No |
| | | (silicone | | glycol | thickening |
| | | oil) 183 g | | 3 g | |
| 6 | 10 | DC 345 fluid | 4 | Water | No |
| | | 108 g + Liponate | | 8 g | thickening |
| | | GC (capric/- | | | |
| | | caprylic | | | |
| | | triglyceride) | | | |
| | | 72 g | | | |
| 7 | 10 | DC 345 fluid | 4 | Hexylene | 2,400 |
| | | 108 g + Liponate | | glycol 6 g + water | |
| | | GC (capric/- | | 8 g | |
| | | caprylic | | | |
| | | triglyceride) | | | |
| | | 72 g | | | |
| 8 | 10 | DC 345 fluid | 5 | Hexylene | 15,000 |
| | | 108 g + Liponate | | glycol 8 g + water | |
| | | GC | | 3 g | |
| | | (capric/- | | | |
| | | caprylic | | | |
| | | triglyceride) | | | |
| | | 72 g | | | |
| 9 | 6 | DC 345 fluid | 3 | Hexylene | 3,000 |
| | | 110.73 g + Liponate | | glycol 6.45 g + water | |
| | | GC (capric/- | | 1.8 g | |
| | | caprylic | | | |
| | | triglyceride) | | | |
| | | 73.82 g | | | |
| 10 | 6 | DC 345 fluid | 0 | Hexylene | No |
| | | 112.53 g + Liponate | | glycol 6.45 g + water | thickening |
| | | GC | | 1.8 g | |
| | | (capric/- | | | |
| | | caprylic | | | |
| | | triglyceride) | | | |
| | | 75.02 | | | |

### EXAMPLE 6

This example shows that a composition of the present invention provided excellent thickening of a hydrophobic liquid, whereas use of a vegetable-derived, long-chain quaternary surfactant as a clay surface modifier did not produce as much thickening in the same liquid. The clay slurries were prepared following a procedure similar to that described in EXAMPLE 5. The quaternary surfactant is available under the tradename Q-2C (containing 75% active) from Tomah Products, Neenah, Wis.

TABLE 6

| | | | | | Brookfield |
|---|---|---|---|---|---|
| Test | Clay | Hydrophobic | | Thickening | Viscosity, |
| No. | (g) | Liquid | Copolymer | Aid | cps 10 rpm |
| 1 | 10 | Mineral Oil | ARLACEL | Hexylene | 9,5000 |
| | | 183 g | P135 | glycol | |
| | | | 4 g | 3 g | |
| 2 | 10 | Mineral Oil | Q-2C | Hexylene | 1,000 |
| | | 183 g | 5.35 g | glycol | |
| | | | | 3 g | |
| 3 | 6 | DC 345 fluid | ARLACEL | Hexylene | 3,000 |
| | | 110.73 g + | P-135 | glycol 6.45 g + | |
| | | Liponate GC | 3 g | Water 1.8 g | |
| | | (capric/ | | | |
| | | caprylic | | | |
| | | triglyceride) | | | |
| | | 73.82 g | | | |
| 4 | 6 | DC 345 fluid | Q-2C | Hexylene | 1,800 |
| | | 110.15 g + | 4 g | glycol 6.42 g + | |
| | | Liponate GC | | Water 1.8 g | |
| | | (capric/ | | | |
| | | caprylic | | | |
| | | triglyceride) | | | |
| | | 73.43 g | | | |

### EXAMPLE 7

This example illustrates some gels of the present invention can be diluted in hydrophobic liquids to provide thickened, final compositions.

### Gel 1

### Composition

| | |
|---|---|
| DC 345 fluid | 94 g |
| LIPONATE GC | 56 g |
| Hexylene glycol | 6 g |
| ARLACEL P-135 | 15 g |
| Bentonite clay | 37.5 g |
| Titanium dioxide (TiO₂) | 7.5 g |
| Water | 3 g |

### Manufacturing Procedure

a) Homogenize all components except water in a Waring blender at 22,000 rpm for 2.5 minutes

b) Add water and homogenize for an additional 3.5 minutes at 22,000 rpm

### Gel 2

### Composition

| | |
|---|---|
| LIPONATE GC | 150 g |
| Hexylene glycol | 6 g |
| ARLACEL P-135 | 15 g |
| Bentonite clay | 37.5 g |
| Titanium dioxide (TiO₂) | 7.5 g |
| Water | 3 g |

### Manufacturing Procedure

a) Homogenize all components except water in a Waring blender at 22,000 rpm for 2.5 minutes

b) Add water and homogenize for an additional 2.5 minutes at 22,000 rpm.

### EXAMPLE 8

This example illustrates an anhydrous mascara formulation that contains a composition of the present invention similar in composition to Gel #1 in Table 1.

Anhydrous Mascara Formulation

| No. | Phase | Ingredient | % by weight |
|---|---|---|---|
| 1 | A | Isododecane | 18.9 |
| 2 | A | C₁₂₋₁₅alkyl Benzoate | 12.0 |
| 3 | A | Capric/Caprylic Triglyceride | 2.0 |
| 4 | A | Candelilia Wax | 2.0 |
| 5 | A | Cyclomethicone | 33.0 |
| 6 | B | Methyl Paraben | 0.2 |
| 7 | B | Propyl Paraben | 0.1 |
| 8 | C | Gel #1 | 20.0 |
| 9 | D | Mica | 1.0 |
| 10 | D | Black Iron Oxide C7133 | 10.3 |
| 11 | D | Ultramarine Blue | 0.5 |

Manufacturing Steps:

Heat Phase A to 80° C.

Mix until uniform.

Add Phase B to Phase A.

Cool the mixture to 60° C., then add Phase C.

Mix until lump free and uniform in a homogenizer.

Add Phase D and homogenize until uniform.

### EXAMPLE 9

This example illustrates a lip color formulation that contains a composition of the present invention similar to Gel #1 in Table 1.

Lip Color Formulation

| No. | Phase | Ingredient | % by weight |
|---|---|---|---|
| 1 | A | Castor Oil | 71.7 |
| 2 | A | Propyl Paraben | 0.3 |
| 3 | A | Red Iron Oxide | 4.0 |
| 4 | A | Yellow Iron Oxide | 1.0 |
| 5 | A | DC Red 7 CA Lake | 1.0 |
| 6 | B | Gel #1 | 20.0 |
| 7 | C | Candelilia Wax | 2.0 |

Manufacturing Steps:

Combine the Phase A ingredients.

Mix in a Silverson L4RT homogenizer, Silverson Machines, Inc., East Longmeadow, Mass., at 5000 rpm until homogeneous.

Add Gel #1 in small portions with mixing at 8,000-10,000 rpm. The temperature rises to above 70° C. while mixing is continued.

Once the composition appears homogeneous and free of lumps, add the molten candelilia wax (preheated to 80° C.) and continue mixing until homogeneous.

Brookfield viscosities of the formulated product at various spindle revolution rates areas follows, showing good shear thinning properties.

| Rpm | Brookfield Viscosity, cps |
|---|---|
| 0.5 | 3,340,000 |
| 10 | 268,400 |
| 20 | 145,800 |

### EXAMPLE 10

This example illustrates an anhydrous roll-on antiperspirant formulation that contains a composition of the present invention similar to Gel #1 in Table 1.

Roll-on Antiperspirant Formulation

| No. | Phase | Ingredient | % by weight |
|---|---|---|---|
| 1 | A | Cyclomethicone | 37.95 |
| 2 | A | Gel #1 | 6.25 |
| 3 | A | C₁₂₋₁₅alkyl benzoate | 29.50 |
| 4 | B | Aluminum zirconium salt | 20.00 |
| 5 | C | Talc | 2.00 |
| 6 | D | Polyoxyethylenemethylpolysiloxane | 4.00 |
| | | copolymer | |
| 7 | D | Fragrance | 0.30 |

Manufacturing Steps:

Mix Phase A ingredients in a Silverson at 3000 rpm for approximately 3 minutes.

Add Phases B and C.

Prepare Phase D together and add Phase D to the batch.

Homogenize in a Silverson.

### EXAMPLE 11

This example illustrates a water-in-oil sunscreen emulsion formulation that contains a composition of the present invention similar in composition to Gel #1 in Table 1.

Water-in-oil Emulsion-based Sunscreen Formulation

| No. | Phase | Ingredient | % by weight |
|---|---|---|---|
| 1 | A | Gel #1 | 6.0 |
| 2 | A | C₁₂₋₁₅alkyl benzoate | 10.0 |
| 3 | A | Octyl methoxycinamate | 5.0 |
| 4 | A | Octyl salicylate | 3.0 |
| 5 | A | Cyclomethicone | 2.0 |
| 6 | A | Hydrophobically modified titanium | |
| | | dioxide, UV-Titan M262 | 5.0 |
| 7 | A | Cetyl polyethylene glycol/polypropylene | 8.0 |
| | | glycol-10/1 dimethicone, ABIL EM 90 | |
| 8 | B | Water | 59.2 |
| 9 | B | Sodium chloride | 0.8 |
| 10 | B | Phenonip | 1.0 |

Manufacturing Steps:

Phase A ingredients using an agitator with a dispersion blade.

Add the premixed Phase B slowly to Phase A.

Continue mixing for a total mix time of 45 minutes.

### EXAMPLE 12

This example illustrates a cream-to-powder eye shadow formulation that contains a composition of the present invention similar to Gel #1 in Table 1.

Cream-to-Powder Eye Shadow Formulation

| No. | Phase | Ingredient | % by weight |
|---|---|---|---|
| 1 | A | Cyclomethicone | 24.8 |
| 2 | A | C₁₂₌₁₅alkyl benzoate | 18.3 |
| 3 | A | Gel #1 | 6.0 |
| 4 | A | Carnuba wax | 2.0 |
| 5 | A | Propylparaben | 0.2 |
| 6 | A | Flamenco super pearl 100 | 5.6 |
| 7 | B | SERICITE PHN | 25.0 |
| 8 | B | SP-29 UVS | 2.8 |
| 9 | B | Titanium dioxide 328 | 6.0 |
| 10 | B | Red iron oxide C33-8075 | 1.3 |
| 11 | B | Yellow iron oxide C33-8073 | 1.9 |
| 12 | B | Black iron oxide C33-5198 | 0.3 |
| 13 | C | AMISOL 4135 | 0.3 |
| 14 | D | Orgasol 2002 EXD NAT COS | 1.5 |
| 15 | D | LIPONYL 10-BN6058 | 1.5 |
| 16 | D | Glycerin | 2.5 |

Manufacturing Steps:

In a suitable vessel add all ingredients of Phase A and heat to 82C.

Mix with a lightning mixer.

Add Phase B to a ribbon type blender and blend until pigment is evenly dispersed.

Add Phase B to Phase A under lightning mixer and mix until uniform.

Add phases C and D, and continue mixing.

Cool batch to 70° C.-75° C. and pour into small containers.

### EXAMPLE 13

This example shows that an amphipathic copolymer such as BIS-PEG 15 dimethicone/IPDI copolymer (polydimethylsiloxane-polyoxyethylene 15 polymer with 3-isocyanatomethyl-3,5,5-trimethylcyclohexyl isocyanate) from Alza International, Sayreville, N.J., also can be used to provide a layered silicate material of the present invention. The resulting surface-modified layered silicate material can be added to a hydrophobic solvent to effectively thicken the solvent.

A gel composition containing the surface-modified layered silicate material was prepared using:

| | | |
|---|---|---|
| Montmorillonite clay | 499 | gm |
| BIS-PEG 15 dimethicone/IPDI copolymer | 450 | gm |
| Dow Corning 345 fluid (silicone fluid) | 1040 | gm |
| Deionized water | 33.3 | gm |
| Propylene carbonate | 100 | gm |

This gelled composition was added to Dow Corning 345 silicone fluid to produce a thickened silicone fluid, as determined by measuring the Brookfield viscosity of the resulting composition, using spindle #6 at 10 and 20 rpm.

| Amount of the Gel Composition, % by | Brookfield Viscosity, |
|---|---|
| weight, in Dow Corning 345 Fluid | cps |
| 30 | 7,400 @ 10 rpm |
| | 4,050 @ 20 rpm |
| 40 | 14,000 @ 10 rpm |
| | 8,800 @ 20 rpm |

Many modifications and variations of the invention as hereinbefore set forth can be made without departing from the spirit and scope thereof and, therefore, only such limitations should be imposed as are indicated by the appended claims.

What is claimed is:

1. A composition for thickening hydrophobic liquids comprising a layered silicate material, surfaces of said layered silicate material modified by an amphipathic copolymer prepared from a first comonomer that generates a hydrophilic homopolymer that is essentially insoluble in a hydrophobic liquid and a second comonomer that generates a hydrophobic homopolymer that is soluble in a hydrophobic liquid.

2. The composition of claim 1 further comprising a thickening aid.

3. The composition of claim 2 wherein the thickening aid is selected from the group consisting of propylene carbonate, hexylene glycol, ethanol, propylene glycol, butylene glycol, water, and mixtures thereof.

4. The composition of claim 1 wherein the hydrophobic liquid comprises one or more nonpolar liquid having a dielectric constant of less than about 10.

5. The composition of claim 1 wherein the hydrophobic liquid is selected from the group consisting of a silicone oil, a mineral oil, a liquid hydrocarbon, a petroleum-derived oil, an ester solvent, a vegetable oil, a flower oil, and mixtures thereof.

6. The composition of claim 1 wherein the layered silicate material comprises a smectite clay, a sodium lithium magnesium silicate, or a mixture thereof.

7. The composition of claim 6 wherein the smectite clay is selected from the group consisting of bentonite, montmorillonite, saponite, hectorite, bidelite, stevensite, and mixtures thereof.

8. The composition of claim 1 wherein the copolymer is a graft copolymer or a block copolymer.

9. The composition of claim 1 wherein the copolymer is soluble or dispersible in hydrophobic liquids having a dielectric constant of less than about 10.

10. The composition of claim 9 wherein the copolymer comprises a triblock copolymer.

11. The composition of claim 10 wherein the triblock copolymer comprises poly(ethylene glycol-30)-co-dipoly(hydroxystearate), BIS-PEG 15 dimethicone/IPDI copolymer, or a mixture thereof.

12. The composition of claim 1 wherein the first comonomer, when polymerized, provides a homopolymer selected from the group consisting of poly(oxyethylene), poly(ethylene glycol), poly-(propylene glycol), poly(vinyl chloride), poly-(acrylate), and poly(acrylamide).

13. The composition of claim 1 wherein the second comonomer, when polymerized, provides a homopolymer selected from the group consisting of poly(hydroxystearate), poly(12-hydroxystearic acid), poly)lauryl methacrylate), polystyrene, poly(dimethylsiloxane), poly(vinyl acetate), poly(methyl methacrylate), and poly(vinyl methyl ether).

14. The composition of claim 1 comprising about 30% to about 90% of the hydrophobic liquid, about 0.5% to about 70% of the layered silicate, and about 0.025% to about 50% of the copolymer, by weight, of the composition.

15. The composition of claim 14 further comprising a thickening aid in an amount of about 0.025% to about 20%, by weight, of the composition.

16. The composition of claim 1 further comprising about 0.1% to about 50%, by weight, of the composition of at least one functional particulate material.

17. The composition of claim 16 wherein the functional particulate material is selected from the group consisting of titanium dioxide, mica, calcium carbonate, kaolinite clay, alumina, talc, zinc oxide, calcium sulfate, iron oxide, an organic pigment, and mixtures thereof.

18. A method of producing the composition of claim 1 comprising dissolving the copolymer in the hydrophobic liquid, adding the layered silicate material, then homogenizing the resulting slurry in a high shear mixer or an extruder.

19. A composition for thickening a hydrophobic liquid, said composition comprising at least one layered silicate material dispersed in a mixture of hexylene glycol and water, and an amphipathic copolymeric surface-modifier for the layered silicate, emulsified in the hexylene glycol and water mixture.

20. The composition of claim 19 wherein the hydrophobic liquid is essentially insoluble in water.

21. The composition of claim 20 wherein the hydrophobic liquid has a dielectric constant of less than about 10.

22. The composition of claim 20 wherein the hydrophobic liquid is selected from the group consisting of a silicone oil, a mineral oil, a liquid hydrocarbon, a petroleum-derived oil, an ester solvent, a vegetable oil, a flower oil, and mixtures thereof.

23. The composition of claim 22 wherein the layered silicate comprises a smectite clay, a lithium magnesium silicate, or a mixture thereof.

24. The composition of claim 23 wherein the smectite clay is selected from the group consisting of bentonite, montmorrilonite, saponite, hectorite, bidelite, stevensite, and mixtures thereof.

25. The composition of claim 20 wherein the copolymeric surface-modifier is prepared from a first comonomer that generates a homopolymer that is essentially insoluble in a hydrophobic liquid, and a second comonomer that generates a homopolymer that is soluble in a hydrophobic liquid, wherein the copolymer is insoluble in water.

26. The composition of claim 25 wherein the first comonomer, when polymerized, provides a homopolymer selected from the group consisting of poly(oxyethylene), poly(ethylene), poly(propylene), poly(vinyl chloride), poly(methyl methacrylate), and poly(acrylamide);
and the second comonomer, when polymerized, provides a homopolymer selected from the group consisting of poly(hydroxystearate), poly(12-hydroxystearic acid), poly(lauryl methacrylate), polystyrene, poly(dimethylsiloxane), poly(vinyl acetate), poly(methyl methacrylate), and poly(vinyl methyl ether).

27. The composition of claim 19 comprising about 0.5% to about 70% of the layered silicate, about 0.025% to about 35% of the copolymeric surface modifier, and about 0.5% to about 20%, of a thickening aid, by weight, of the composition.

28. The composition of claim 19 further comprising about 0.1 to about 30%, by weight, of the composition, of at least one functional particulate material selected from the group consisting of titanium dioxide, calcium carbonate, kaolinite clay, alumina, talc, zinc oxide, calcium sulfate, an organic pigment, and iron oxide.

29. A method of thickening a hydrophobic composition comprising adding a sufficient amount of the composition of claim 1 to the hydrophobic composition to provide a predetermined viscosity.

30. The method of claim 29 wherein the hydrophobic composition is selected from the group consisting of a cosmetic product, a personal care product, and a pharmaceutical product.

31. The method of claim 29 wherein the hydrophobic composition is selected from the group consisting of a liquid makeup, an eye shadow, a mascara, a lip color, a nail product, an antiperspirant, a deodorant, a pharmaceutical product, a sunscreen, a paint, and a coating product.

32. A method of dispersing a particulate material in a hydrophobic solvent comprising adding the particulate material to the hydrophobic solvent, and adding a sufficient amount of the composition of claim 1 to the hydrophobic solvent to disperse and suspend the particulate material in the hydrophobic solvent.

33. The method of claim 32 wherein the particulate material is selected from the group consisting of titanium dioxide, calcium carbonate, kaolinite clay, alumina, talc, zinc oxide, calcium sulfate, an organic pigment, iron oxide, and mixtures thereof.
